(19) United States
(12) Patent Application Publication
(10) Pub. No.: US 2021/0377613 A1
(43) Pub. Date: Dec. 2, 2021

(54) DIGITAL SYSTEM INCLUDING VIRTUAL SEATING

(71) Applicants: Willie J. Sims, Brandon, MS (US); Gregory Proctor, Brandon, MS (US)

(72) Inventors: Willie J. Sims, Brandon, MS (US); Gregory Proctor, Brandon, MS (US)

(21) Appl. No.: 17/104,333

(22) Filed: Nov. 25, 2020

Related U.S. Application Data
(60) Provisional application No. 63/033,283, filed on Jun. 2, 2020.

(51) Int. Cl. H04N 21/472; H04N 21/2187; H04N 21/81; H04N 21/478

(52) U.S. Cl. CPC H04N 21/472; H04N 21/47815; H04N 21/8133; H04N 21/2187

(57) ABSTRACT

A digital system including virtual seating, includes at least hardware, software, data storage and a network for interconnecting the system. The digital system includes a user device including an application facilitating selection of a virtual seat corresponding to a physical seat at an event venue. The virtual seat has a seat position and a unique perspective relative to the event venue. The user device displays a 360° view of the stadium from the unique perspective relative to the event venue. The user device, after selection of the virtual seat, receives and displays live stream audio and video corresponding to the seat position and unique perspective.

### CROSS-REFERENCE TO RELATED APPLICATION

The present application is related to and claims the priority benefit of U.S. Provisional Patent Application No. 63/033,283, filed on Jun. 2, 2020, the entire contents of which are incorporated herein by reference.

### TECHNICAL FIELD

This specification relates to the field of software. More specifically, the present technology is in the technical field of software-based digital systems for virtual seating and distance measurement in the context of a particular event.

### BACKGROUND

When it comes to technology, one thing you can count on is that nothing is going to stay the same. Technology answers the demands of the constantly evolving society of today with quick response, which means it is constantly evolving as well.

To cope with the changing technological environment, recent changes in the technical field must be adapted to gain the advantage of new technology. In addition to competition, technology is also advanced by filling unmet needs. That is, technology often comes about as a solution or alternative to identified needs.

The present novel technology, which may be implemented to offer alternative means for experiencing an event, targets various existing needs in traditional event attendance.

### SUMMARY

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an environment in which a digital system for virtual seating and distance measurement may operate, according to an exemplary embodiment of the present disclosure.

FIG. 2 depicts exemplary services accessed by various device platforms, according to an aspect of the present disclosure.

FIG. 3 depicts a user flow diagram, according to another aspect of the present disclosure.

FIG. 4a depicts a screen capture illustrating a feature of the system of the present disclosure.

FIG. 4b depicts a screen capture illustrating another feature of the system of the present disclosure.

FIG. 4c depicts a screen capture illustrating another feature of the system of the present disclosure.

FIG. 5a depicts a screen capture illustrating another feature of the system of the present disclosure.

FIG. 5b depicts a screen capture illustrating another feature of the system of the present disclosure.

FIG. 5c depicts a screen capture illustrating another feature of the system of the present disclosure.

FIG. 6a depicts a screen capture illustrating a feature of the system of the present disclosure.

FIG. 6b depicts a screen capture illustrating another feature of the system of the present disclosure.

FIG. 6c depicts a screen capture illustrating another feature of the system of the present disclosure.

FIG. 7a depicts a screen capture illustrating a feature of the system of the present disclosure.

FIG. 7b depicts a screen capture illustrating another feature of the system of the present disclosure.

FIG. 7c depicts a screen capture illustrating another feature of the system of the present disclosure.

FIG. 8 depicts a a screen capture illustrating a feature of the system of the present disclosure.

FIG. 8b depicts a screen capture illustrating another feature of the system of the present disclosure.

FIG. 8c depicts a screen capture illustrating another feature of the system of the present disclosure.

FIG. 9 depicts a screen capture illustrating a feature of the system of the present disclosure.

FIG. 9b depicts a screen capture illustrating another feature of the system of the present disclosure.

FIG. 9c depicts a screen capture illustrating another feature of the system of the present disclosure.

FIG. 10 depicts a screen capture illustrating team statistics displayed on the user device.

FIG. 11a depicts a screen capture illustrating another feature of the system of the present disclosure.

FIG. 11b depicts a screen capture illustrating another feature of the system of the present disclosure.

FIG. 11c depicts a screen capture illustrating another feature of the system of the present disclosure.

Like reference numbers and designations in the various drawings indicate like element.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not. Additionally, “generates,” “populates,” “generating,” and “populating” mean that the system or module may produce some event or cause some event element to be produced. For example, a webpage may receive data to display in whole or in part to display a valuation estimate to an end user device, the webpage may pull such data from a source other than system (e.g., other servers, intermediaries, etc.), or system may entirely provide the valuation estimate to be produced on the webpage.

“Click,” “touch,” and “tap” are terms that typically may be used interchangeably. For example, on a mobile device, users typically touch or tap the screen to select items or press buttons. On a laptop, smartphone, and/or desktop users typically click with a mouse but may in some implementations use a touchscreen or the like interface.

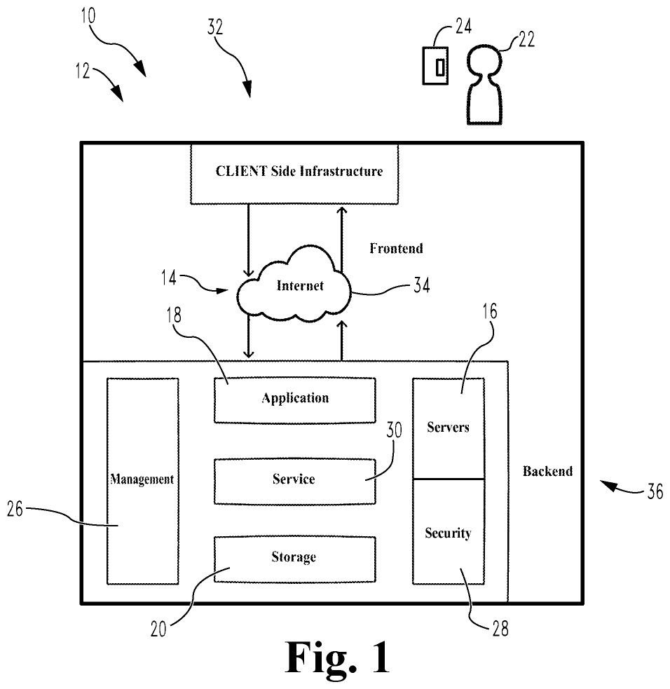

FIG. 1 is a block diagram 10 of an exemplary environment in which the digital system for virtual seating and distance measurement (“system”) 12 of the present disclosure may operate. The exemplary environment, which may or may not utilize “the cloud” 14, may include a plurality of servers 16, along with software 18 and databases 20 capable of running on the servers 16. Software and/or applications 18 implementing the system 12 of the present disclosure may be hosted on one or more of the servers 16.

The system 12 may be implemented using a variety of different digital environments and should not be limited to the exemplary embodiment that is provided. For example, the system 12 may be a web based application or may be a cloud based application. Further, major components of a digital environment may include websites, cloud servers, search engines, social media outlets, mobile apps, audio and video, and other web-based resources, to name a few. The system 12 may also include load balancing, application fire walling, and various other components for improving operation and security of the system 12.

Various users 22, using any one of a variety of different user devices 24, may access the system 12 as described herein, such as, for example, via the Internet. Exemplary user devices 24 may include desktop computers, mobile phones, tablets, smart TVs, etc. A variety of different users 22 may use the system 12 with respect to any of a variety of different functionalities and/or services offered by the system 12.

The one or more databases 20 may be used to store a variety of information needed for operating the system 12, including, for example, user accounts and profiles, profile settings, user preferences, and various information about events and event venues, and various other information that may or may not be unique to the system for virtual seating and distance measurement 12. Types of information that may be stored may include images, text, media files, etc. The system 12 may also include management 26, security 28 and services 30. The client side infrastructure 32 makes up the frontend of the system architecture, while the components accessed by the frontend via the Internet 34 may be considered the backend 36.

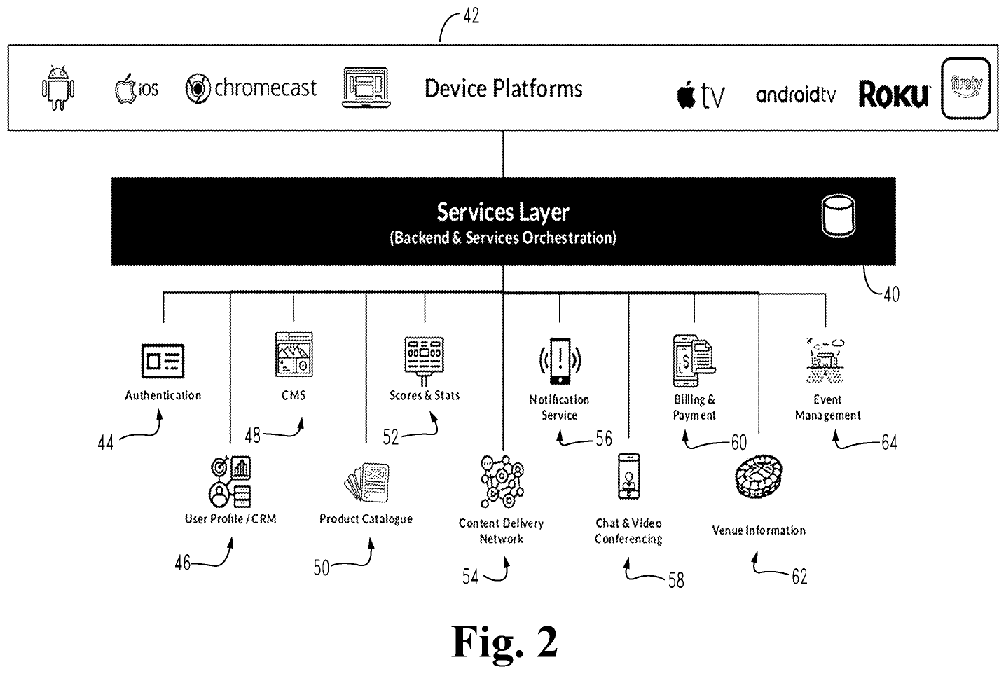

FIG. 2 depicts an exemplary services layer 40, such as in cloud computing, accessed by various device platforms 42, according to an aspect of the present disclosure. Cloud computing services cover a vast range of options, from the basics of storage, networking, and processing power through to natural language processing and artificial intelligence. The services described herein are provided for exemplary purposes only. The exemplary services are described below.

Authentication services 44 may be used for controlling access to applications and servers from various devices and networks. For example, security attacks on the cloud service provider may be reduced by utilizing the authentication service.

A customer relationship management tool 46 helps organize and access customer data in real-time. The tool includes a process of managing interactions. It allows a company to manage analyze its own interactions with its past, current and potential customers.

A content management system 48 is a software or application that uses a database to manage content. Content management is a set of processes and technologies that supports the collection, managing, and publishing of information in any form or medium. When stored and accessed via computers, this information may be more specifically referred to as digital content, or simply as content.

A service catalog 50 is a comprehensive list of IT services that an organization offers to its employees or customers. This catalog is the only portion of the company's service portfolio that is published and provided to customers as a support to the sale or delivery of offered IT services.

Scores and stats 52 may result from analyzing information expressed in numbers, for example, stats based on a participant or sporting event. A quarterback, for example, may be judged statistically on all levels of football by their passing accuracy, the number of touchdowns they throw, the number of interceptions they throw, the number of interceptions they throw and the number of yards they gain by passing.

A content delivery network 54 is a distributed group of servers that work together to provide fast delivery of Internet content. A content delivery network is a network of geographically dispersed servers that enables faster web performance by locating copies of web content closer to end users 22 or facilitating delivery of dynamic content (e.g., live video feeds).

A notification or messaging service 56 may deliver information from the app to the mobile device 24 with or without a request from the user 22. The notification or messaging services 56 may include a cloud service for coordinating the delivery of push messages from software applications to subscribing endpoints and clients. Service users also have the flexibility to send direct messages to several devices or to one subscriber by using a sole publish request.

The system 12 may also include chat and video conferencing as an architectural pattern for message validation, message transformation and message routing. It mediates communication amongst applications, minimizing the mutual awareness that applications should have of each other in order to be able to exchange messages, effectively implementing decoupling.

With reference to a billing and payment service 60, billing and payment transactions may include billing and payment features such as viewing and paying a bill, reviewing payment history and selecting billing and payment options, such as paperless billing. Links are available to customers to take common billing actions such as viewing more details about their current comparing previous bills, exploring their energy use, and changing their utility account communication preferences.

Venue information 62 may include the size of a venue, such as a stadium, and capacity of the venue. Venue information may also include regulations or policies that pertain to safety and security. Further, venue information may include a variety of different venue characteristics for use by the present disclosure.

Event management 64 may be used to define a process that helps leverage automation to manage events to become more effective and efficient.

A cloud application simply refers to any software application that is deployed in a cloud environment rather than being hosted on a local server or machine. A private cloud environment acts as a private network, creating a secure environment for applications, services and users.

According to the present disclosure, one or more applications may implement and operate a digital system for virtual seating and distance measuring 12.

In software, a module is a part of a program. Programs are composed of one or more independently developed modules that are not combined until the program is linked. A single module can contain one or several routines.

The features and capabilities of the system 12 will be described in greater detail below.

FIG. 3 depicts a user flow diagram 80 illustrating a user experience provided by the system 12 and method of the present disclosure. The user flow begins when a user 22 wants to experience a live event, at 82. When the app of the present disclosure is launched by a user 22 via a user device 24, an events preview, at 82, may be provided. The system 12 of the present disclosure may enable searching through numerous events, including, for example, sporting events and concerts, to identify events of interest.

The system 12 and method provided herein allow a user 22 to view different pricing tiers, such as, for example “single,” “season ticket,” and “stadium section and row.” The method also presents a user 22 with options regarding pricing information. As such, the user 22 may consider pricing when proceeding to purchase a ticket for the event.

A 3D seat preview, with a 360° view, may be provided, at 84, via the app such that the user 22 can visualize the view of the event from different seats. After the user 22 has selected a desired seat for the event, a ticket may be purchased, at 86, through the app. According to some embodiments, a user profile is created and stored in a database automatically during the seat purchasing process or a user 22 may be prompted to enter such profile information.

On the day of the event, at 88, the app is launched, the event is initiated, and the live event begins. As part of the user experience, the user 22 may be provided with the option, at 90, of an introduction to the event, e.g., a 3D fly-over from outside the event venue to inside the event venue and all the way to the seat location, at 92. The user 22 can then view the live event virtually from the viewpoint of the selected seat, at 94.

According to an exemplary embodiment, the system 12 monitors for significant moments, at 96, including, for example, a touchdown in a football game. When a significant moment occurs, a merchandise purchasing opportunity is provided. That is, the user device 24 displays an option to purchase memorabilia, responsive to the identification of a significant moment, via the user device 24. This feature, at 98, provides an easy way for a user 22 to make a purchase. A significant moment may be a time during which a user 22 is more likely to purchase memorabilia.

The user 22 may remain engaged with the live event, even during after play analysis, at 100, such as by the incorporation of spot measurements. The details of spot measurements will be provided below.

When there is a break in the live performance, at 102, there may be live entertainment, at 104, including, for example, a half-time show, e.g., during a timeout or intermission. This provides continued engagement throughout the event and through to the next event. Further, a top level, at 108, navigation menu, which may be accessible via the live event view or other locations within the app, may also provide engagement by facilitating access to various features of the app. For example, a top level navigation menu may include an “app tutorial” 110, “merchandise shop” 112, “chat functionality” 114, and “stats” 116.

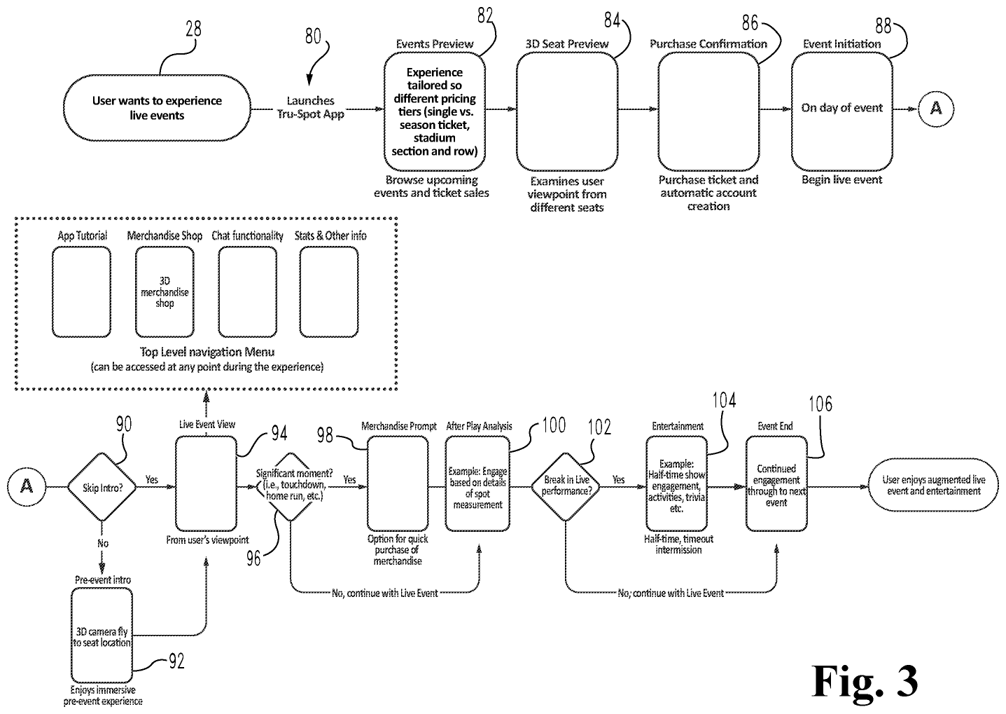

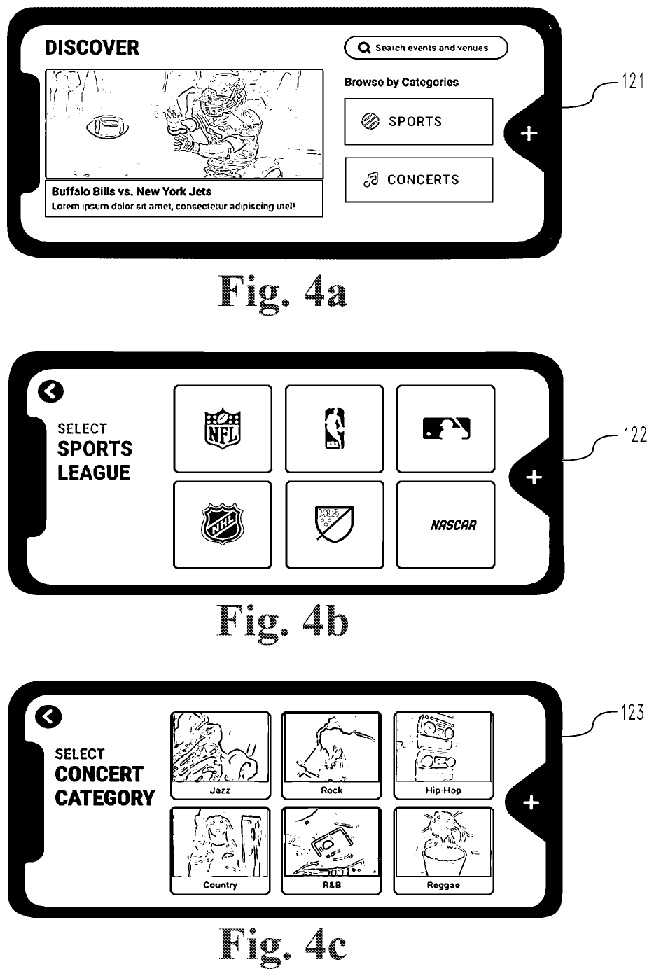

FIGS. 4a, 4b and 4c depict a progression of screen captures 120 illustrating features and flow of the app of the present disclosure. At screen 121, a new user 22 may browse by event categories, such as, for example, sports and concerts. If the user 22 selects “sports” the user 22 will be directed to a screen 122 showing various sports leagues. After a league is selected, the user 22 will be directed to available NFL teams. If a specific NFL team is selected, the user 22 is provided with games/events for the selected NFL team.

In a similar fashion, and returning to screen 121, if the user 22 selects “concerts,” the user 22 will be directed to a screen 123 showing various concert categories. Concert genres and events will be displayed for the user 22 in a manner similar to the sequence described with respect to the “sports” category.

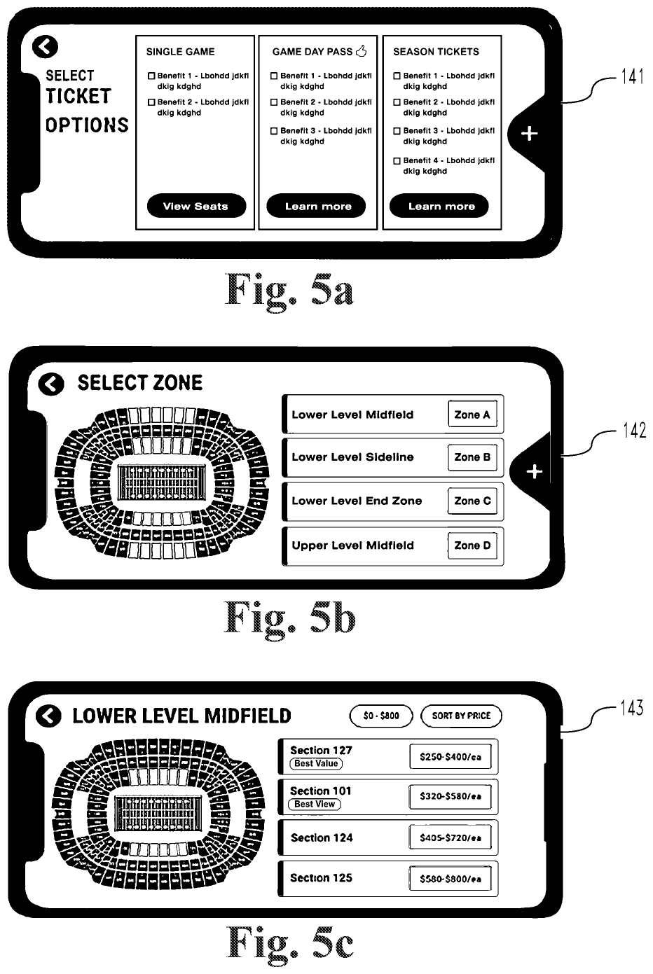

FIGS. 5a, 5b and 5c depicts a progression of screen captures 140 illustrating features and flow of the app of the present disclosure. At screen 141, different ticket options and price tiers are provided. For example, the user 22 may be offered to select a single game ticket, a game day pass, and season tickets. Various other options may also be provided, depending on the event and other factors. At screen 142, the user 22 may select between various zones of the venue seats. At screen 143, the user 22 may be able to further narrow the location of a desired seat. According to the exemplary embodiment, a section, within a selected zone, may be selected by the user 22.

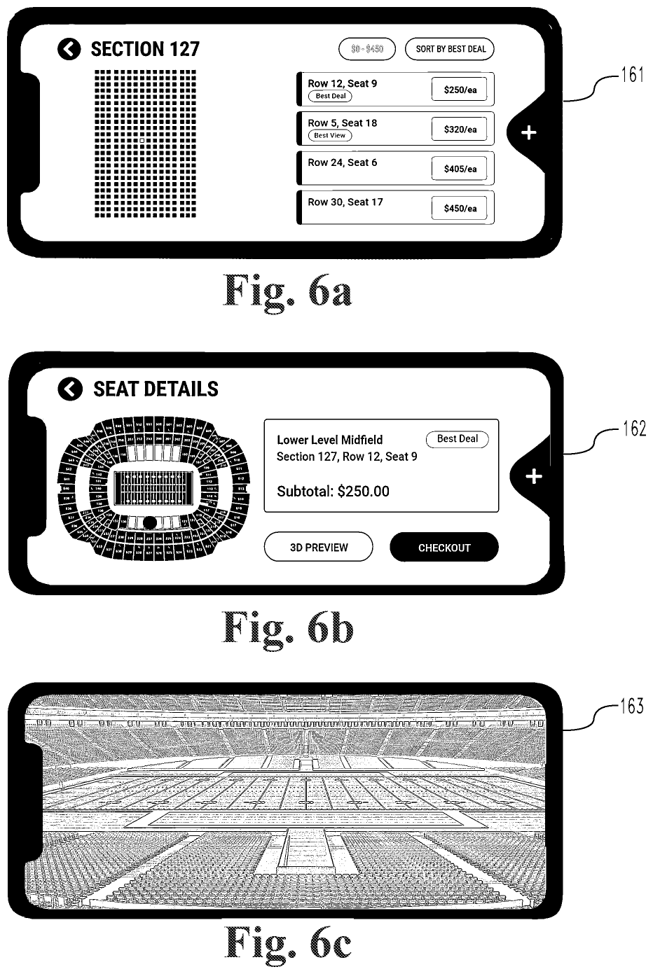

FIGS. 6a, 6b and 6c depicts another progression of screen captures 160 illustrating features and flow of the app of the present disclosure. Screens 161 and 162 show section and seat details for a selected seat. At screen 163, a 3D preview of the venue from the perspective of the selected seat is provided. As such, the user 22 may visualize the view of the event from the seat position of the selected seat using the user device 24.

A user 22 of the system 12 can select a virtual seat for a particular event at an event venue using a user device 24. The virtual seat has a seat position and a seat perspective relative to the event venue or, rather, a 3D rendering of the event venue. As shown, a seating chart of the event venue may be provided for selecting a desired seat, along with pricing information for various available seats. Virtual seats may be purchased using this interface.

The system 12 may include a GPS that provides position and/or movement information relevant to the user's seat position or seat perspective. According to some embodiments, the players/participants are GPS equipped, such as by using a player worn device, and communicate their GPS position to a server. The users have a user device that accepts the player's position and selectively renders a view of the event from the user's perspective or location. Additionally, the software overlays data, including measurement data, on the live stream video.

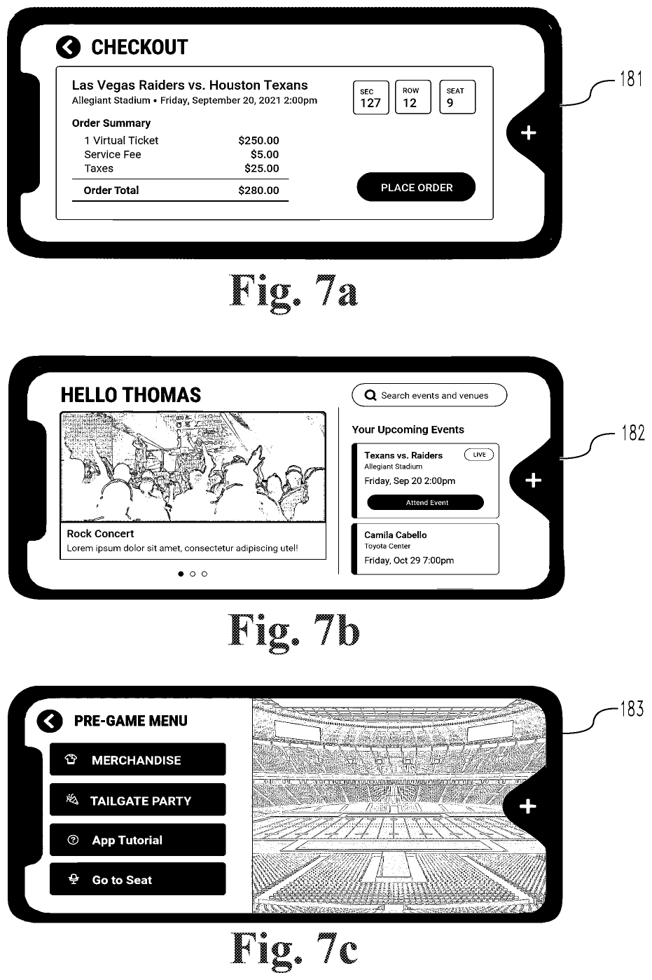

FIGS. 7a, 7b and 7c depicts a progression of screens 180 including an illustration of the check-out/purchase of seat tickets, at screen 181. The user 22 may be logged in and may access a “homepage,” shown at screen 182, of the user 22, which provides various information, including upcoming events for the user 22. At screen 183, a pre-game menu may be provided for the user 22. The screen may permit the user 22 to navigate to “merchandise,” “tailgate party,” “app tutorial,” and “go to seat.” The merchandise store may be accessed by the user 22, with screens for individual selected merchandise to be displayed.

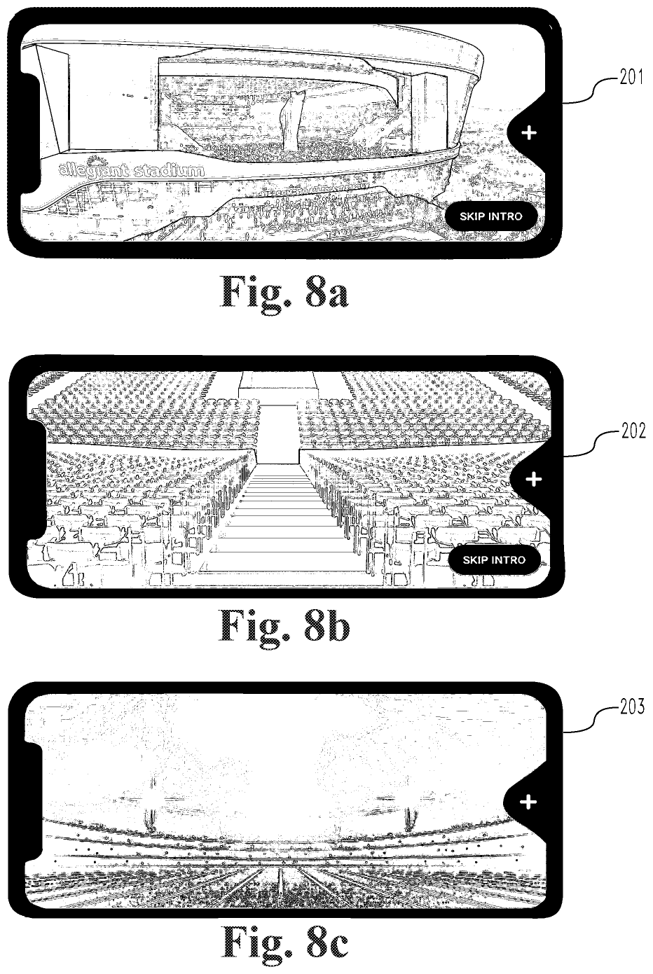

The system 12 of the present disclosure includes additional features, such as, for example, and according to FIGS. 8a, 8b and 8c, the user 22 may select an optional fly-over, as an intro to the event. As shown in a progression of screens 200, 201, 202 and 203 the fly-over may include a view from outside the stadium and into the stadium to the seat location.

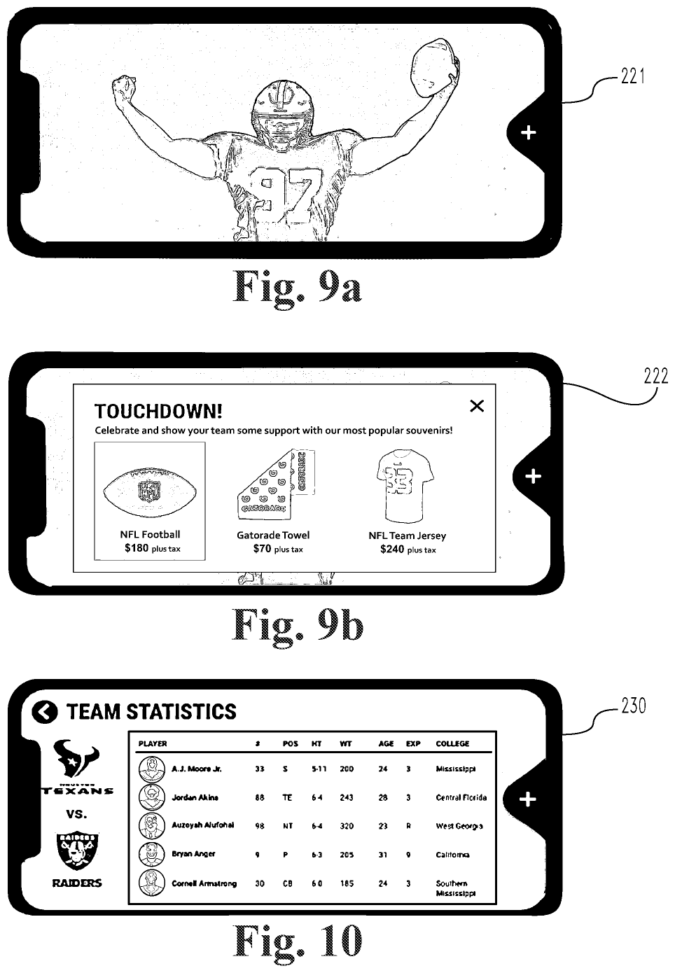

According to an exemplary embodiment, shown in FIGS. 9a, 9b and 9c, and referencing screen 220, the system 12 monitors for significant moments, including, for example, a touchdown in a football game, at 221. When a significant moment occurs, merchandise purchasing opportunity is provided, at 222. That is, the user device 24 displays an option to purchase memorabilia, via a user interface at screen 222, responsive to the identification of a significant moment, at screen 221, via the user device 24. This feature provides an easy way for a user 22 to make a purchase. A significant moment may be a time during which a user 22 is more likely to purchase memorabilia.

Some of the data measured or otherwise gathered may be used to enhance the user experience, provide more accurate information and provide statistics for players. According to the exemplary embodiment, the software overlays data, including measurement data, on the live stream video.

Stats, illustrated on screen 230 of FIG. 10, may be calculated and displayed on the user device 24. Some of the most common stats, e.g., for football, may include yards, carries, passes, receptions, touchdowns, sacks, interceptions, and fumbles. In addition to player or team stats, instant replays or football spot measurements can be provided.

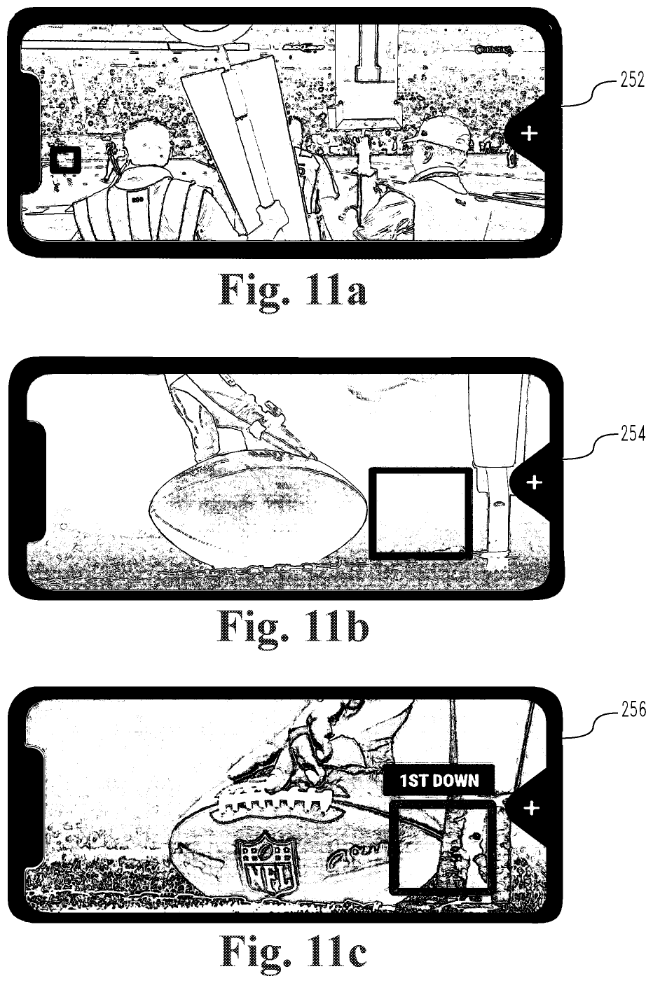

FIGS. 11a, 11b and 11c illustrate, using screens 252, 254 and 256 of the progression 250, measurements/spotting, which may improve inexact spotting of the ball. If the previous play ends between the hash marks, the ball is spotted where that play ended. If the play ends outside the hash marks, the ball is spotted about 1½ yards inside the nearest hash.

The digital system 12 for virtual seating and distance measurement may use one or more of virtual reality, augmented reality, visual positioning system, global positioning system, machine learning, and visual recognition algorithms to provide the virtual seating and distance measurement of the present disclosure. Features of the system 12 may include online virtual seat purchase, seat assignment, and virtual fan attendance at events. The system 12 may also provide distance measurement relevant to a particular event. For example, with regard to football, the system 12 may establish, for example, yardage measurement, football movement, and player, or participant, movement. According to some embodiments, the location and measurement technologies may be used in conjunction with a user device 24 for displaying measurement results, along with various other information.

Virtual reality refers to a computer-generated simulation in which a person can interact within an artificial three-dimensional environment using electronic devices. Augmented reality overlays digital content and information onto the physical world. Machine learning algorithms use statistics to find patterns in massive amounts of data stored in digital form. Visual recognition algorithms are used to analyze and understand visuals from a single image or a sequence of images. Global positioning systems use a global navigation satellite system that provides location, velocity and time synchronization. Visual positioning systems allow the device to virtually localize images of the surrounding environment for creating a 3D environment.

During the event, the user 22 may enjoy the energy and immersion of attending live events that is missing from broadcast screening. Users 22 may also enjoy the camaraderie of attending events with groups of other people.

Fans may want to take selfies or pictures with friends and family at the event. Fans may want to post pictures, vides, and updates to social media during live events.

During a break in the event, the user 22 is anticipating a half-time show or using this opportunity for a quick break, browse souvenirs, or get food/drinks.

After the event, the user 22 is left with an emotional high peak and often wish to continue engaging (i.e., postgame parties or concert encores). The users enjoy memorabilia to remember event attendance and as part of collectible sets.

1. A digital system including virtual seating, including at least hardware, software, data storage and a network for interconnecting the system, the digital system including:
a user device including an application facilitating selection of a virtual seat corresponding to a physical seat at an event venue, wherein the virtual seat has a seat position and a unique perspective relative to the event venue;
the user device displaying a 360° view of the stadium from the unique perspective relative to the event venue; and
the user device, after selection of the virtual seat, receiving and displaying live stream audio and video corresponding to the seat position and unique perspective.

2. The digital system of claim 1, wherein the application calculates measurement data with regard to objects in the live stream audio and video.

3. The digital system of claim 2, wherein the application overlays the measurement data on the live stream audio and video.

4. The digital system of claim 3, wherein the measurement data includes a yardage measurement.

5. The digital system of claim 1, wherein the user device is configured to overlay statistics data relative to an event participant on the live stream audio and video.

6. The digital system of claim 1, wherein the application is configured to facilitate purchase of merchandise.

7. The digital system of claim 6, wherein the application is configured to display a prompt regarding the purchase of merchandise in response to a predetermined moment.

8. The digital system of claim 1, wherein the user device facilitates messaging or chatting among attendees of the event during the live stream audio and video.

9. The digital system of claim 1, wherein the user device facilitates creation of an avatar.

10. The digital system of claim 9, wherein the application facilitates attendance of a virtual social gathering by the avatar.

11. The digital system of claim 1, wherein the user device displays a 3D view of a navigation path extending from outside the event venue to the seat position.
